(19) United States
(12) Patent Application Publication
(10) Pub. No.: US 2023/0055233 A1
(43) Pub. Date: Feb. 23, 2023

(54) Method of Training Voice Recognition Model and Voice Recognition Device Trained by Using Same Method

(71) Applicant: LLSOLLU CO., LTD., Seoul (KR)

(72) Inventors: Chang Jin Ji, Seoul (KR); Myeong Jin Hwang, Seoul (KR)

(21) Appl. No.: 17/798,801

(22) PCT Filed: Feb. 5, 2021
(86) PCT No.: PCT/KR2021/001570

§ 371 Date: Aug. 10, 2022

(30) Foreign Application Priority Data
Feb. 11, 2020 (KR) 10-2020-0016351

(51) Int. Cl. G10L 15/06; G10L 15/02; G10L 15/187

(52) U.S. Cl. CPC G10L 15/063; G10L 15/02; G10L 15/187; G10L 2015/025

(57) ABSTRACT

A method of training a voice recognition model to convert voice data to text data, according to one embodiment of the present invention, comprises the steps of: receiving the voice data input; converting the voice data into one or more grapheme data items using the voice recognition model; generating one or more word candidates corresponding to the one or more grapheme data items by using the voice recognition model; determining, on the basis of context, one of the word candidates as the text data that corresponds to the voice data, by using the voice recognition model; and adding a weight to one or more rules associated with generation of the word candidate determined as the text data, by using a back propagation value generated on the basis of the text data.

### TECHNICAL FIELD

The present invention relates to a method for learning a speech recognition model and a speech recognition apparatus learned by the above method.

### BACKGROUND ART

Speech-to-text is a technology for generating text matching with input speech.

In general, a learning process of a speech recognition device typically goes through processes of: acquiring speech data and text data corresponding to the speech data (speech-text parallel data); securing P2G (Phoneme-to-Grapheme) technique to convert text symbols (phonemes and graphemes) into voice symbols (pronunciation or phonetic symbols); converting the speech-text symbol parallel data into speech-voice symbol parallel data using P2G; training an acoustic model to generate voice symbols from speech data; and learning a language model using large-capacity text.

In this regard, the text symbol corresponding to the speech data is not expressed as a phonetic symbol but is usually expressed as a general character according to a standard notation, this is because there is a problem in that securing speech-voice symbol parallel data expressing the speech-text symbol parallel data in voice symbols needs several times the cost and time, compared to securing speech-text parallel data.

However, since it is also time-consuming and costly to obtain speech-text symbol parallel data written in general characters, it needs to be improved.

### DISCLOSURE

### Technical Problem

Accordingly, in order to solve the problem by the present invention, there is provided a method for learning a speech recognition model without securing speech-text parallel data and speech-voice symbol parallel data, as well as a speech recognition apparatus to convert speech data into text data using the speech recognition model learned by the above method.

However, the problems to be solved by the present invention are not limited to those mentioned above, and other problems to be solved, which are not mentioned herein, would be clearly understood from the following description by those skilled in the art to which the present invention pertains.

### Technical Solution

According to an embodiment of the present invention, a method for learning a speech recognition model to convert speech data into text data may include: receiving the speech data; converting the speech data into one or more phonetic symbol data using the speech recognition model; generating one or more word candidates corresponding to the one or more phonetic symbol data using the speech recognition model; determining one of the word candidates as the text data corresponding to the speech data, on the basis of a context, using the speech recognition model; and assigning weighted values to one or more rules related to generation of the word candidate determined as the text data using a back-propagation value generated based on the text data.

The generation of the one or more word candidates may include generating the one or more word candidates based on the mapping of phonetic symbol sequence segments generated from the phonetic symbol data and grapheme sequence segments generated from general text data.

The generation of the one or more word candidates may include: mapping one or more phonetic symbol sequence segments, which are selected in the order of the greatest number among the phonetic symbol sequence segments generated from the phonetic symbol data, along with one or more grapheme sequence segments, which are selected in the order of the greatest number among the grapheme sequence segments generated from the general text data; and generating the one or more words using the above mapping of the one or more phonetic symbol sequence segments and the one or more grapheme sequence segments.

The back-propagation value may be used to assign a weighted value to a rule related to generation of phonetic symbol data serving as the basis of the word candidate determined as the text data.

The back-propagation value may be used to assign a weighted value to a rule related to mapping of phonetic symbol sequence segments and grapheme sequence segments, which serve as the basis of the word candidate determined as the text data.

The back-propagation value may be used to a weighted value to a rule related to the word candidate determined as the text data.

The context may include one or more among a context including a grapheme, a letter or a morpheme, a sentence structure, a word class (or part-of-speech) and a sentence component.

According to another embodiment of the present invention, there is provided a speech recognition apparatus for converting speech data into text data by executing a speech recognition model, which includes: an input/output device for receiving speech data input; a memory for storing information on the speech recognition model; and a processor that executes the speech recognition model to convert the speech data into the text data, wherein the speech recognition model may: convert the speech data into one or more phonetic symbol data using the speech recognition model; generate one or more word candidates corresponding to the one or more phonetic symbol data using the speech recognition model; determine any one among the word candidates as the text data corresponding to the speech data, on the basis of a context, using the speech recognition model; and assign weighted values to one or more rules related to the generation of the word candidate determined as the text data using a back-propagation value generated based on the text data.

### Advantageous Effects

According to an embodiment of the present invention, a speech recognition model can be learned without securing speech-to-text parallel data and speech-voice (or phonetic) symbol parallel data, thereby attaining effects of dramatically reducing time and cost required to perform speech recognition.

### DESCRIPTION OF DRAWINGS

FIG. 1 is a block diagram illustrating a speech recognition apparatus according to an embodiment of the present invention.

FIG. 2 is a block diagram conceptually illustrating a method for leaning a speech recognition model according to an embodiment of the present invention.

FIG. 3 illustrates a method of mapping a phonetic symbol sequence segment and a grapheme sequence segment according to an embodiment of the present invention.

FIG. 4 is a block diagram illustrating a function of an acoustic model according to an embodiment of the present invention.

FIG. 5 is a block diagram illustrating functions of a segment generation and segment mapping unit according to an embodiment of the present invention.

FIG. 6 is a block diagram illustrating a function of a P2G model according to an embodiment of the present invention.

FIG. 7 is a block diagram illustrating a function of a language model according to an embodiment of the present invention.

FIG. 8 is a flowchart illustrating a method of learning a speech recognition model according to an embodiment of the present invention.

### BEST MODE

In a most preferred form, the present invention proposes,

a method for learning a speech recognition model to convert speech data into text data, the method including: receiving speech data input; converting the speech data into one or more phonetic symbol data using the speech recognition model; generating one or more word candidates corresponding to the one or more phonetic symbol data using the speech recognition model; determining any one of the word candidates as the text data corresponding to the speech data, on the basis of a context, using the speech recognition model; and assigning weighted values to one or more rules related to generation of the word candidate determined as the text data using a back-propagation value generated based on the text data,

wherein the generation of the one or more word candidates may include:

mapping one or more phonetic symbol sequence segments, which are selected in the order of the greatest number among the phonetic symbol sequence segments generated from the phonetic symbol data, along with one or more grapheme sequence segments, which are selected in the order of the greatest number among the grapheme sequence segments generated from the general text data; and generating the one or more words using the above mapping of the one or more phonetic symbol sequence segments and the one or more grapheme sequence segments.

Further, in another most preferred form, the present invention proposes

a speech recognition apparatus for converting speech data into text data by executing a speech recognition model, the apparatus including: an input/output device for receiving speech data input; a memory for storing information on the speech recognition model; and a processor that executes the speech recognition model to convert the speech data into the text data,

wherein the speech recognition model may:

convert the speech data into one or more phonetic symbol data using the speech recognition model;

generate one or more word candidates corresponding to the one or more phonetic symbol data using the speech recognition model;

determine any one among the word candidates as the text data corresponding to the speech data, on the basis of a context, using the speech recognition model;

assign weighted values to one or more rules related to the generation of the word candidate determined as the text data using a back-propagation value generated based on the text data;

convert general text data distinguishable from the speech data into one or more grapheme sequence data;

map one or more phonetic sequence segments, which are selected in the order of the largest number among the phonetic sequence segments generated from the phonetic symbol data, along with one or more grapheme sequence segments, which are selected in the order of the largest number among the grapheme sequence segments generated from the grapheme sequence data; and then, generate the one or more word candidates using the above mapping of the one or more phonetic symbol sequence segments and the one or more grapheme sequence segments.

### Detailed Description of Preferred Embodiments of Invention

Advantages and features of the present invention and methods of achieving the same will become apparent with reference to the embodiments described below in detail in conjunction with the accompanying drawings. However, the present invention is not limited to the embodiments disclosed below, but may be implemented in various different forms. Only these embodiments allow the disclosure of the present invention to be complete, and are provided to fully inform those skilled in the art, to which the present invention pertains, the scope of the invention. Therefore, the present invention is only defined by the scope of the appended claims.

With regard to the description of the embodiments of the present invention, if it is determined that a detailed description of well-known functions or configurations may unnecessarily obscure the gist of the present invention, the detailed description thereof will be omitted. Further, the terms to be described later are terms defined in consideration of functions in the embodiments of the present invention, which may vary according to intentions or customs of users and operators. Therefore, the definition should be made based on the content throughout the present specification.

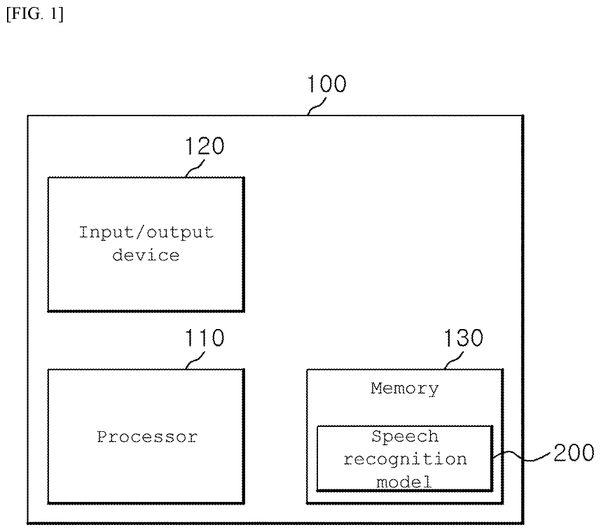

FIG. 1 is a block diagram illustrating a speech recognition apparatus according to an embodiment of the present invention.

Referring to FIG. 1, the speech recognition apparatus 100 may include a processor 110, an input/output device 120 and a memory 130.

The processor 110 may control overall operations (functions) of the speech recognition apparatus 100.

The processor 110 may receive one or more speech data using the input/output device 120.

The input/output device 120 may include one or more input units and/or out or more output unit. For example, the input/output device may include an input unit such as a microphone, a keyboard, a mouse and a touch screen, and/or an output unit such as a display and a speaker.

According to an embodiment, the processor 110 may receive one or more speech data using a transceiver (not shown).

The memory 130 may store the speech recognition model 200 and information required for executing the speech recognition model 200.

The processor 110 may load the speech recognition model 200 and information required for executing the speech recognition model 200 from the memory 130 so as to execute the speech recognition model 200.

The processor 110 may execute the speech recognition model 200, in order to convert the speech data inputted using the input/output device 120 into the corresponding text data, and then output the converted result through the input/output device 120.

The speech recognition model 200 may be a model (program) that has been learned or is being learned to perform speech recognition, or may include a model (program) that has been learned or is being learned to perform speech recognition.

According to an embodiment, the processor 110 may transmit the converted result through a transceiver (not shown).

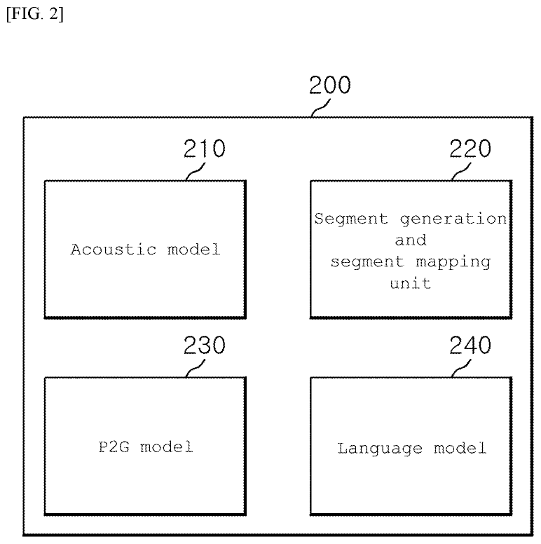

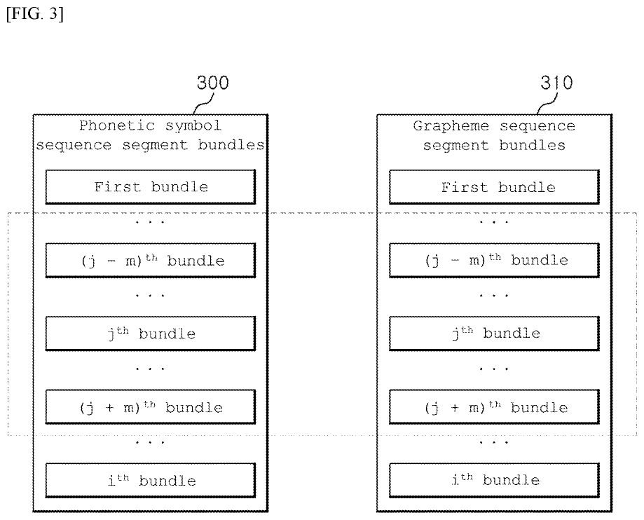

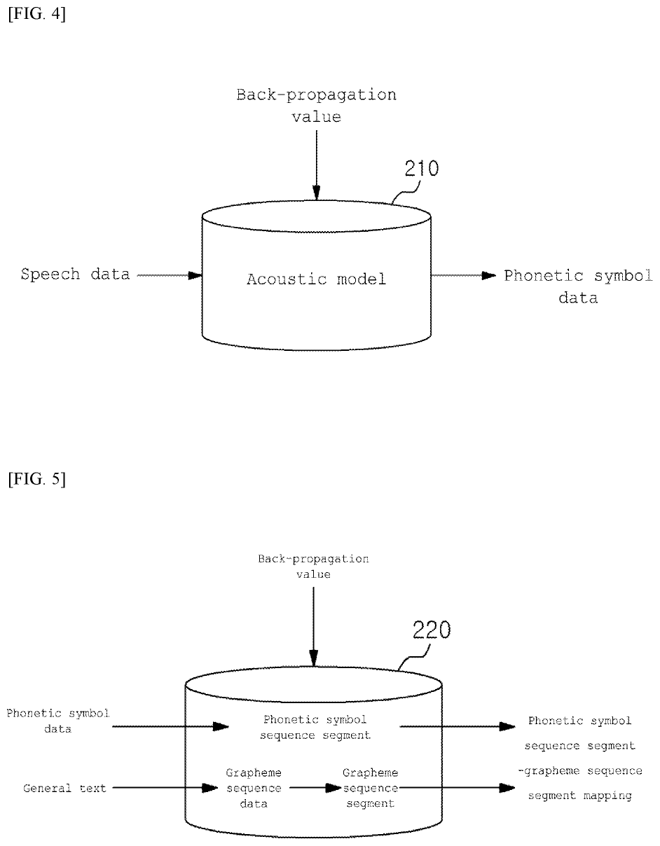

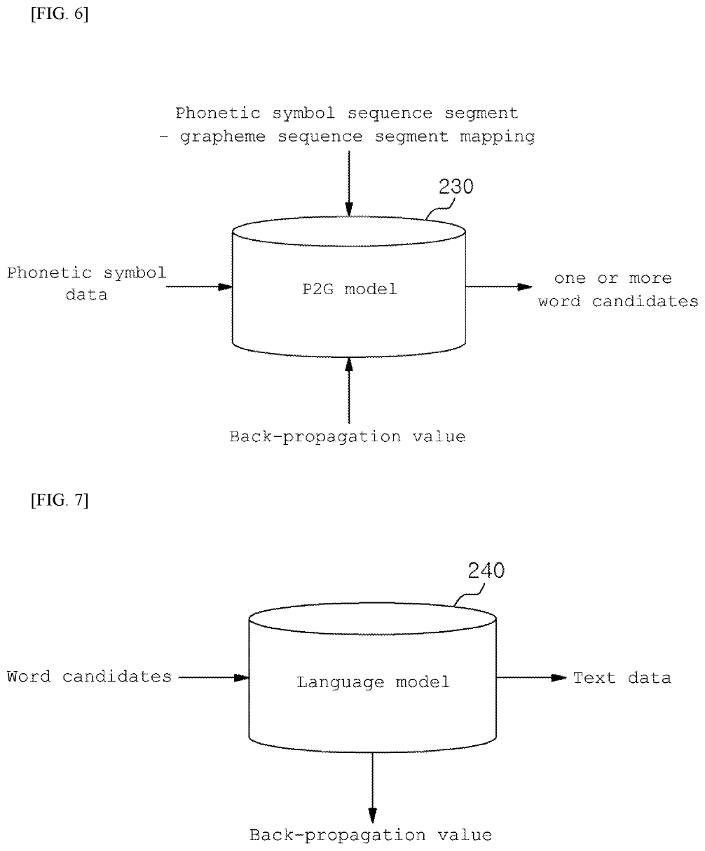

FIG. 2 is a block diagram conceptually illustrating a method for learning a speech recognition model according to an embodiment of the present invention; FIG. 3 illustrates a method of mapping a phonetic symbol sequence segment and a grapheme sequence segment according to an embodiment of the present invention; FIG. 4 is a block diagram illustrating a function of an acoustic model according to an embodiment of the present invention; FIG. 5 is a block diagram illustrating functions of a segment generation and segment mapping unit according to an embodiment of the present invention; FIG. 6 is a block diagram illustrating a function of a P2G model according to an embodiment of the present invention; and FIG. 7 is a block diagram illustrating a function of a language model according to an embodiment of the present invention.

Referring to FIG. 2, the speech recognition model 200 may include an acoustic model 210, a segment generation and segment mapping unit 220, a P2G model 230 and a language model 240.

The acoustic model 210, the segment generation and segment mapping unit 220, the P2G model 230 and the language model 240 are only conceptual divisions of functions of the speech recognition model 200 for easily illustrative purposes of the functions of the speech recognition model 200, are not particularly limited thereto. According to embodiments, the acoustic model 210, the segment generation and segment mapping unit 220, the P2G model 230 and the language model 240 may be implemented as a series of instructions included in one program, or each thereof may be implemented as a single program (software).

In the present specification, for convenience of explanation, it has been described that the acoustic model 210 and/or the P2G model 230 included in the speech recognition model 200 are learned, but the present invention is not limited thereto. In other words, according to an embodiment, the acoustic model 210 and/or the P2G model 230 are not learned as a part of the speed recognition model 200, but the speech recognition model 200 itself may be learned.

Further, in the present specification, a model may mean a computer program composed of instructions capable of performing functions and operations according to respective names described in the present specification. That is, the speech recognition model 200 may be a kind of computer program (application software) executed by a processor and stored in a memory.

Further, referring to FIG. 4, the acoustic model 210 may receive speech data input and convert the input speech data into corresponding pronunciation (that is, phonetic) symbol data. At this time, the phonetic symbol data may refer to data indicating the pronunciation of speech data (expressed in a voice form) in the form of a symbol. For example, if the acoustic model 210 receives speech data corresponding to “eating”, the acoustic model 210 may generate phonetic symbol data representing {“i”, “d”, “i”, “ [symbol] ”} corresponding to “eating”. The above phonetic symbol data may include one or more phonetic symbol sequences.

According to an embodiment, the acoustic model 210 may generate a plurality of phonetic symbol data using the speech data. That is, since the phonetic symbol data generated by the acoustic model 210 is possibly incorrect depending on a learning level of the acoustic model 210, the acoustic model 210 may generate a plurality of phonetic symbol data having a possibility of correct answer as a result of converting a single speech data.

According to an embodiment, the acoustic model 210 may be an artificial neural network that has already been trained or is being trained, otherwise, may be a model that has been learned (or is being learned) using probability, statistics, patterns, rules, probability graph, and the like.

Further, referring to FIG. 5, the segment generation and segment mapping unit 220 may generate a plurality of phonetic symbol sequence segments from the phonetic symbol data generated by the acoustic model 210. The phonetic symbol data may include one or more phonetic symbol sequences, and each phonetic symbol sequence may include phonetic symbols. The segment generation and segment mapping unit 220 may extract one or more phonetic symbols among the phonetic symbols included in each of the one or more phonetic symbol sequences so as to generate a phonetic symbol sequence segment. The phonetic symbol sequence segment may be generated in the number of cases in which the start and end of the segment are selected for each phonetic symbol sequence (ₙH₂: the number of cases in which total two positions comprising one starting position and one ending position in the phonetic symbol sequence having a length of n are selected).

Further, the segment generation and segment mapping unit 220 may receive general text data input separately from the speech data, and convert the general text data into grapheme sequence data.

The segment generation and segment mapping unit 220 may generate a plurality of grapheme sequence segments from the grapheme sequence data. The grapheme sequence data may include one or more grapheme sequences, and each grapheme sequence may include graphemes. The segment generation and segment mapping unit 220 may extract one or more graphemes from the graphemes included in each of the one or more grapheme sequences so as to generate the grapheme sequence segment. The grapheme sequence segment may be generated in the number of cases in which the start and end of the segment are selected for each grapheme sequence (ₙH₂: the number of cases in which total two positions comprising one starting position and one ending position in the grapheme sequence having a length of n are selected).

The segment generation and segment mapping unit 220 may map a phonetic symbol sequence segment and a grapheme sequence segment, on the basis of: the statistics of the phonetic symbol sequence segments included in the phonetic symbol data and composed of one or more phonetic symbols; and the statistics of the grapheme sequence segments included in the grapheme sequence data and composed of one or more graphemes. For example, the segment generation and segment mapping unit 220 may compare the frequency (number) of phonetic sequence segments with the frequency (number) of grapheme sequence segments, and then, map the phonetic symbol sequence segments and the grapheme sequence segments based on the ranking of the frequencies. This is because the phonetic symbol sequence segments found with high frequency and the corresponding grapheme sequence segments are also highly likely to be found with high frequency.

For example, the segment generation and segment mapping unit 220 may map the most frequent phonetic symbol sequence segment (or one or more most frequent phonetic symbol sequence segments) among the phonetic symbol sequence segments included in the phonetic symbol data along with the most frequent grapheme segment (or one or more most frequent grapheme segments) among the graphemes included in the general text data.

According to an embodiment, the mapping between the phonetic symbol sequence segment and the grapheme sequence segment may not be a 1:1 mapping. Mapping of phonetic sequence segments and grapheme sequence segments is for extracting a pair of phonetic sequence segment and grapheme sequence segment that may possibly correspond to each other. In this regard, words often used in speech may also be expected to be used frequently in text, however, the phonetic symbol data generated by the acoustic model 210 is likely inaccurate and the phonetic symbol sequence often used in speech may not exactly match with the grapheme sequence often used in text. Therefore, mapping of the phonetic symbol sequence segment and the grapheme sequence segment may be 1:k or k:1 mapping (wherein k is a natural number).

For example, referring to FIG. 3, it may be assumed a case where the segment generation and segment mapping unit 220 divides all the phonetic symbol sequence segments generated from the phonetic symbol data into i equal parts (i is a natural number) to generate phonetic symbol sequence segment bundles 300, while diving all the grapheme sequence segments generated from the grapheme sequence data into i equal parts to generate grapheme sequence segment bundles 310. At this time, the segment generation and segment mapping unit 220 may extract a pair of phonetic symbol sequence segment and grapheme sequence segment, assuming that phonetic symbol sequence segments of (j−m)^{th} bundle to (j+m)^{th} bundle among the phonetic symbol sequence segment bundles 300 and the grapheme sequence segment bundles 310 and grapheme sequence segments of (j−m)^{th} bundle to (j+m)^{th} bundle among the grapheme sequence segment bundles 310 are paired each other.

Referring to FIG. 6, when the phonetic symbol data generated by the acoustic model 210 is input, the P2G model 230 may be trained to generate one or more word candidates corresponding to the input phonetic symbol data. In this regard, the word candidate means a candidate of text data representing the speed data, which is the basis of the phonetic symbol data, in text, and is due to the fact that the speech data able to be inferred from the phonetic symbol data (or the text data corresponding to the speech data) is not the only one.

According to an embodiment, the P2G model 230 may be learned in a supervised learning method. The P2G model 230 may be learned using the mapping between the phonetic symbol sequence segment and the grapheme sequence segment.

For example, when the phonetic symbol data represents {“r”, “a”, “i”, “t”}, a speech data (or text data) able to be inferred from {“r”, “a”, “i”, “t”} may be “right”, “write”, “light”, etc., therefore, the word candidates may include “right”, “write” and “light”.

The P2G model 230 may receive input of a plurality of phonetic symbol data generated by the acoustic model 210 and generate one or more word candidates corresponding to each of the plurality of phonetic symbol data.

According to an embodiment, the P2G model 230 may be a model learned (or being learned) using a neural network, probability, statistics, patterns, rules, probability graphs, and the like.

Further, referring further to FIG. 7, the language model 240 may determine any one of the one or more word candidates generated by the P2G model 230 as the text data corresponding to the speech data. According to an embodiment, the language model 240 may determine any one of the word candidates as the text data corresponding to the speech data based on the context. The context may include one or more among a context such as graphemes, letters and words, a sentence structure, a part-of-speech, and a sentence component. That is, the language model 240 may determine the most natural word candidate among one or more word candidates as the text data based on a context such as graphemes, letters or words, a sentence structure, a part-of-speech, and a sentence component.

For example, when the speech data input to the acoustic model 210 is “Turn right at the corner”, the acoustic model 210 may generate phonetic symbol data corresponding to {“r”, “a”, “i”, “t”} in regard to “right” included in the speech data, while the P2G model 230 may generate word candidates including “right” and “wright” in response to the phonetic symbol data corresponding to {“r”, “a”, “i”, “t”}. In this case, the language model 240 may determine “right” among candidates such as “right” and “wright” based on the context.

The word or word candidate may be understood as a part of a sentence. The part of the sentence may be a unit of grapheme.

The phonetic symbol data generated by the acoustic model 210 may not actually be in a form that could be inferred by a person, such as {“r”, “a”, “i”, “t”}. Further, in the early stage of learning, the phonetic symbol sequence for the speech data “right” may be generated occasionally and erratically, for example, {“o”, “l”, “f”, “o”, “t” }, and even if the phonetic symbol sequence comes out normally such as {“r”, “a”, “i”, “t”}, it may also be given a case where the word candidate is generated erratically like “lotto off”. However, if using the back-propagation value of the language model 240, negative (minus) weighted values may be assigned to the relevant generation (conversion) rules or positive (plus) weighted values may be assigned to the generation (conversion) rules related to correctly generated (converted) data, thereby excluding the above erratically generated word candidates from the learning.

In general, inappropriate results may be generated at the beginning of learning, but erroneously formed rules at the beginning of learning are discarded whereas new correctly formed rules are highlighted so that the acoustic model 210 and/or the P2G model 230 may be learned in more efficient way with reduced side effects.

The above rule may also be understood, that is, as a neural network or a probability graph.

To this end, in order to train the acoustic model 210 and/or the P2G model 230, the language model 240 may transmit a back-propagation value including information on the text data determined based on the context to the acoustic model 210 and/or the P2G model 230. In other words, when the acoustic model 210 generates a plurality of phonetic symbol data and the P2G model 230 generates a plurality of word candidates, the acoustic model 210 may assign a weighted value to the rule contributing to generation of the finally determined text data on the basis of the back-propagation value, and the P2G model 230 may also assign a weight value to the rule contributing to generation of the finally determined text data on the basis of the back-propagation value. Accordingly, the acoustic model 210 and the P2G model 230 may be trained to generate more accurate phonetic symbol data and word candidates using information on the text data received from the language model 240.

The method for training the P2G model 230 described with reference to FIG. 6 is deduced from the assumption that a ranking of the frequency of appearance of phonetic symbols (sequences) (segments) extracted from speech data are similar to a ranking of the frequency of appearance of graphemes (sequences) (segments) extracted from general text data. When using the above method, the learning data to train the P2G model 230 may be secured even though the text data corresponding to the speech data is not obtained.

A method of verifying and reinforcing the P2G model 230 and the acoustic model 210 recited in FIGS. 4 and 6 may identify a part to be reinforced and a part to be weakened in the rules of the acoustic model 210 and/or the P2G model 230 by notifying the acoustic model 210 and/or the P2G model 230 through the language model 240 what is correct or incorrect among the results of P2G and, eventually, the learning can be guided in a direction of improving accuracy.

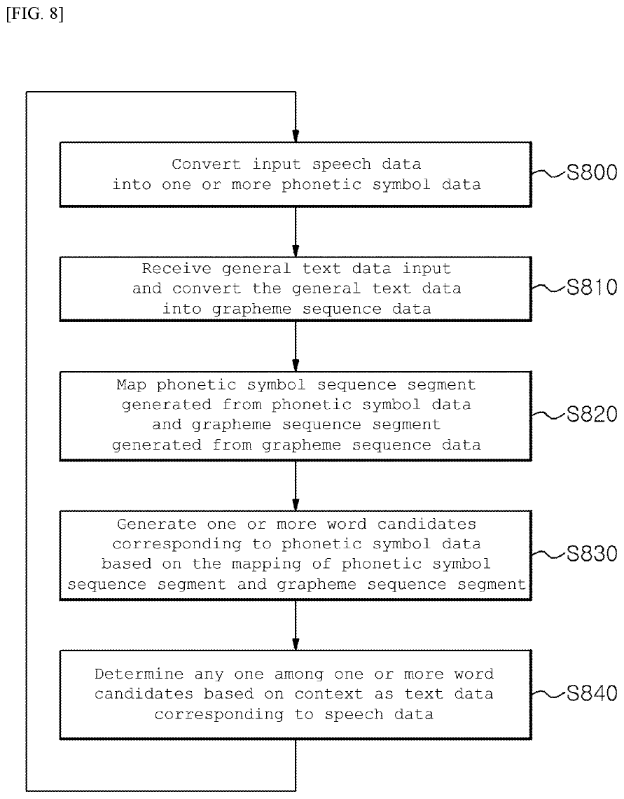

FIG. 8 is a flowchart illustrating a method for learning a speech recognition model according to an embodiment of the present invention.

Referring to FIGS. 2 to 8, the acoustic model 210 may receive speech data input and convert the input speed data into one or more phonetic symbol data (S800).

The segment generation and segment mapping unit 220 may receive general text data separately from the speech data and convert the general text data into grapheme sequence data (S810).

In FIG. 8, for convenience of explanation, although it is illustrated that the conversion to the grapheme sequence data is performed after the conversion to the phonetic symbol data, the present invention is not limited thereto. In other words, the conversion to phonetic symbol data and the conversion to the grapheme sequence data may not have precedence, and the conversion to the phonetic symbol data may be performed after the conversion to the grapheme sequence data is first performed. Alternatively, these two operations may be performed simultaneously.

The segment generation and segment mapping, unit 220 may map the phonetic sequence segments and the grapheme sequence segments, based on: the statistics of the phonetic symbol sequence segments generated from the phonetic symbol data and the statistics of the grapheme sequence segments generated from the grapheme sequence data (S820).

The P2G model 230 may receive input of the mapping of the phonetic sequence segment and the grapheme sequence segment, and then, generate one or more word candidates corresponding, to the phonetic symbol data, on the basis of the mapping of the phonetic symbol sequence segment and the grapheme sequence segment (S830).

The language model 240 may determine any one of the one or more word candidates as the text data corresponding to the speech data based on the context (S840).

The language model 240 may transmit a back-propagation value according to the text data to the acoustic model 210 as a feedback for one or more phonetic symbol data converted by the acoustic model 210. Further, the language model 240 may transmit a back-propagation value according to the text data to the P2G model 230 as a feedback for one or more word candidates generated by the P2G model 230.

The acoustic model 210, the segment generation and segment mapping unit 220 and/or the P2G model 230 may assign weighted values to the above steps (S300 to S340) using the back-propagation values received from the language model 240, thereby being more learned.

That is, the acoustic model 210 may be further learned by assigning weighted values to the neural network, rule, probability graph, etc. involved in the generation of phonetic symbol data, on the basis of the word candidate determined as the text data, using the back propagation value.

The segment generation and segment mapping unit 220 may be further learned by assigning weighted values to the neural networks, rules, probability graphs, etc. involved in the mapping of the phonetic symbol sequence segment and the grapheme sequence segment, on the basis of the word candidate determined as the text data, using the back-propagation value.

The P2G model 230 may be further learned by assigning weighted values to the neural network, rule, probability graph, etc. involved in the generation of the word candidate determined as the text data using the-back propagation value.

Combinations of separate Hocks in the block diagram and separate steps in the flowchart attached in the present invention may be performed by computer program instructions. These computer program instructions may be loaded in an encoding processor of any general purpose computer, special purpose computer or other programmable data processing equipment, such that the instructions executed by the encoding processor of the computer or other programmable data processing equipment may generate a means for performing the functions described above in separate blocks in the block diagram or separate steps in the flowchart. In order to implement the functions in a specific manner, the computer program instructions may also be stored in a computer-useable or computer-readable memory which may direct the computer or other programmable data processing equipment, whereby the instructions stored in the compute-useable or computer-readable memory may also produce any manufactured item containing an instruction means for performing the functions recited in separate blocks of the block diagram or separate steps of the flowchart. The computer program instructions may also be loaded in a computer or other programmable data processing equipment, such that, as a result of a series of operational steps implemented on the computer or other programmable data processing equipment to produce a computer-executed process, instructions to operate the computer or other programmable data processing equipment may possibly provide steps for performing the functions recited in separate blocks of the block diagram and separate steps of the flowchart.

Further, each block or each step may represent a module, a segment or a portion of code that includes one or more executable instructions for performing specified logical function(s). Further, it should also be noted that, in some alternative embodiments the functions recited in the blocks or steps may also proceed out of order. For example, it is possible that two blocks or steps present in succession may be substantially executed simultaneously, or that the above blocks or steps may be executed in reverse order according to the corresponding functions.

The above description is merely illustrative of the technical idea of the present invention, and various modifications and variations will be possible without departing from the essential quality of the present invention by those skilled in the art to which the present invention pertains. Therefore, the embodiments disclosed in the present invention are not intended to limit the technical spirit of the present invention but to specify the same, and the scope of the technical spirit of the present invention is not limited by these embodiments. The protection scope of the present invention should be interpreted by the following appended claims, and all technical ideas within the scope equivalent thereto should be construed as being included in the scope of the present invention.

1. A method for learning a speech recognition model to convert speech data into text data, comprising:
receiving speech data input;
converting the speech data into one or more phonetic symbol data using the speech recognition model;
generating one or more word candidates corresponding to the one or more phonetic symbol data using the speech recognition model;
determining any one of the word candidates as the text data corresponding to the speech data, on the basis of a context, using the speech recognition model; and
assigning weighted values to one or more rules related to generation of the word candidate determined as the text data using a back-propagation value generated based on the text data,
wherein the generation of the one or more word candidates includes:
mapping one or more phonetic symbol sequence segments, which are selected in the order of frequency of appearance among the phonetic symbol sequence segments generated from the phonetic symbol data, into one or more grapheme sequence segments, which are selected in the order of the greatest number among the grapheme sequence segments generated from the general text data; and generating the one or more words using the above mapping of the one or more phonetic symbol sequence segments and the one or more grapheme sequence segments.

2. The method according to claim 1, wherein the back-propagation value is used to assign a weighted value to a rule related to generation of phonetic symbol data serving as the basis of the word candidate determined as the text data.

3. The method according to claim 1, wherein the back-propagation value is used to assign a weighted value to a rule related to mapping of phonetic symbol sequence segments and grapheme sequence segments, which serve as the basis of the word candidate determined as the text data.

4. The method according to claim 1, wherein the back-propagation value is used to a weighted value to a rule related to the word candidate determined as the text data.

5. The method according to claim 1, wherein the context includes one or more among a context including graphemes, letters or morphemes, a sentence structure, a word class (or part-of-speech) and a sentence component.

6. A speech recognition apparatus for converting speech data into text data by executing a speech recognition model, comprising:
an input/output device for receiving speech data input;
a memory for storing information on the speech recognition model; and
a processor that executes the speech recognition model to convert the speech data into the text data,
wherein the speech recognition model:
converts the speech data into one or more phonetic symbol data using the speech recognition model;
generates one or more word candidates corresponding to the one or more phonetic symbol data using the speech recognition model;
determines any one among the word candidates as the text data corresponding to the speech data, on the basis of a context, using the speech recognition model;
assigns weighted values to one or more rules related to the generation of the word candidate determined as the text data using a back-propagation value generated based on the text data;
converts general text data distinguishable from the speech data into one or more grapheme sequence data;
maps one or more phonetic sequence segments, which are selected in the order of the largest number among the phonetic sequence segments generated from the phonetic symbol data, along with one or more grapheme sequence segments, which are selected in the order of the largest number among the grapheme sequence segments generated from the grapheme sequence data; and then, generates the one or more word candidates using the above mapping of the one or more phonetic symbol sequence segments and the one or more grapheme sequence segments.

7. The apparatus according to claim 6, wherein the back-propagation value is used to assign a weighted value to a rule related to generation of phonetic symbol data serving as the basis of the word candidate determined as the text data.

8. The apparatus according to claim 6, wherein the back-propagation value is used to assign a weighted value to a rule related to mapping of phonetic symbol sequence segments and grapheme sequence segments, which serve as the basis of the word candidate determined as the text data.

9. The apparatus according to claim 6, wherein the back-propagation value is used to a weighted value to a rule related to the word candidate determined as the text data.

10. The apparatus according to claim 6, wherein the context includes one or more among a context including graphemes, letters or morphemes, a sentence structure, a word class (or part-of-speech) and a sentence component.

11. A computer-readable recording medium for storing a computer program,
wherein the computer program includes an instruction by which a processor executes the method according to claim 1.

12. A computer program stored in a computer-readable recording medium,
wherein the computer program includes an instruction by which a processor executes the method according to claim 1.
